(19) United States
(12) Patent Application Publication
(10) Pub. No.: US 2019/0110633 A1
(43) Pub. Date: Apr. 18, 2019

(54) MULTIFUNCTIONAL DRINK MAKING APPARATUS

(71) Applicant: Jikai Liang, Shenzhen (CN)

(72) Inventor: Jikai Liang, Shenzhen (CN)

(21) Appl. No.: 15/786,340

(22) Filed: Oct. 17, 2017

(51) Int. Cl. A47J 31/44

(52) U.S. Cl. CPC A47J 31/4403; A47J 31/06

(57) ABSTRACT

In one aspect, a multifunctional drink making apparatus may include a main body that includes a water storage tank, a cold water pump and a hot water pump which are connected with the water storage tank respectively. A plurality of water filters can be connected from the water storage tank to improve the water quality. The drink making apparatus also includes an intelligent control display to intelligently control the hot water output to brew coffee, tea or the like according to the preference of the user. More importantly, the intelligent control display screen is connected with a wireless module, so the user can use an external electronic device to control the drink making apparatus through the intelligent control display to achieve the goal of internet of things, and increase the convenience and practicability of the drink making apparatus.

### FIELD OF THE INVENTION

The present invention relates to a household appliance, and more particularly to a multifunctional drink making machine which is configured to purify water and make multiple kinds of drinks such as tea and coffee.

### BACKGROUND OF THE INVENTION

Currently, a household water drinking machine can only be used to provide hot and cold water, and the water tank of the water drinking machine has to be frequently replaced, which is very inconvenient to the user. Also, people have more concern about the safety issue of the water tanks. In addition, conventional water drinking machines are too simple in terms of functionality. For example, conventional water drinking machines cannot be used to make other kinds of drinks, such as coffee and tea. Therefore, there remains a need for a multifunctional drink making machine to overcome the problems stated above.

### SUMMARY OF THE INVENTION

It is an object of the present invention to provide a multifunctional drink making apparatus which is configured to make various kinds of drinks, such as water, tea and coffee.

It is another object of the present invention to provide a multifunctional drink making apparatus which is configured to purify the water before making drinks.

It is a further object of the present invention to provide a multifunctional drink making apparatus which can be wirelessly controlled by an electronic device.

In one aspect, a multifunctional drink making apparatus may include a main body that includes a water storage tank, a cold water pump and a hot water pump which are connected with the water storage tank respectively. In one embodiment, the water storage tank can be directly connected with a tap water pipe or other water sources. A plurality of water filters may be arranged between the water storage tank and the tap water pipe. In one embodiment, the water filters can be disposed inside the drink making apparatus. In another embodiment, the water filters can be disposed outside the drink making apparatus.

The cold water pump and the hot water pump are connected with a cold water outlet and a hot water outlet through pipelines respectively. A sterilization device is disposed on each of the cold water pump/the cold water outlet as well as the hot water pump/the hot water outlet. In one embodiment, the sterilization device is an ultraviolet sterilization device. In another embodiment, the sterilization device is an ozone sterilization device or other disinfection and sterilization devices with equivalent effects. The multifunctional drink making apparatus may further include a rapid heating component disposed between the hot water pump and the hot water outlet to quickly heat up the water.

It is important to note that the drink making apparatus includes an intelligent control display connected with the Internet and can be used to control the rapid heating component, the cold water pump and the hot water pump with a switch. The intelligent control display can be connected with a mobile terminal or the Internet through a wireless module and a wired router module arranged therein to control the rapid heating component, the cold water pump and the hot water pump, so an external electronic device can be used to remotely control of output of cold water and hot water of the drink making apparatus in the present invention.

The drink making apparatus further includes a bench arranged below the hot water outlet and a detachable funnel is provided to receive ground coffee, tea leaves and the like. A cup space is used for placing a cup therein below the bench and the funnel is connected with the cup space, and a filtering unit is disposed between the funnel and the cup space, so that the intelligent control display can be used to control the hot water outlet to brew coffee, tea leaves or the like in the funnel. Again, the intelligent control display is connected with the wireless module, so it can be remotely controlled by external electronic devices.

The present invention is advantageous because the drink making apparatus can be directly connected with tap water, and a user can connect multiple water filters internally or externally from the water storage tank to improve the water quality to solve the issue of frequently replacing the water storage tank. The user can replace the water filters and wash the water storage tank periodically to control and maintain the water quality. Moreover, the drink making apparatus includes an intelligent control display to intelligently control the hot water output to brew coffee, tea or the like according to the preference of the user. More importantly, the intelligent control display screen is connected with the wireless module, so the user can use an external electronic device to control the drink making apparatus through the intelligent control display to achieve the goal of internet of things, and increase the convenience and practicability of the drink making apparatus.

### BRIEF DESCRIPTION OF THE DRAWINGS

FIG. 1 is a schematic view of the multifunctional drink making apparatus in the present invention.

FIG. 2 illustrates a schematic view of the water storage tank connecting with cold water pump/the cold water outlet and the hot water pump/the hot water outlet.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

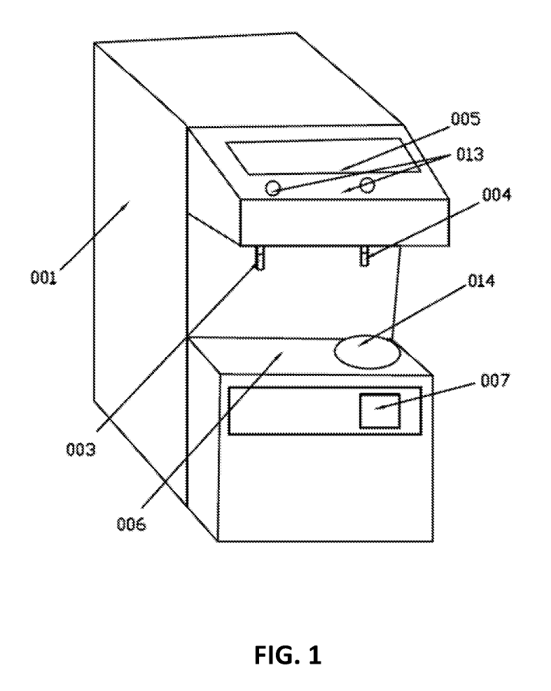

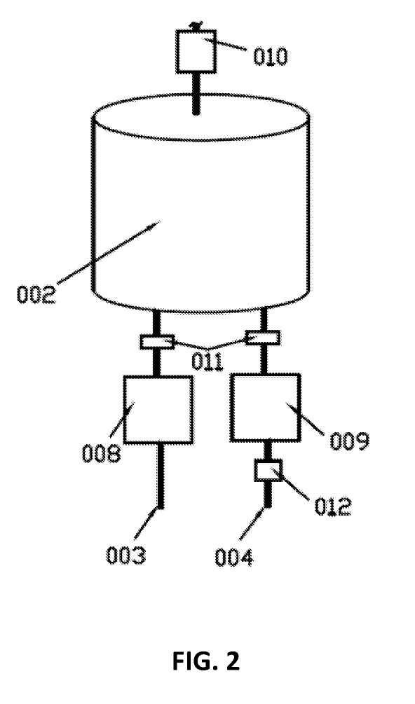

Referring to FIGS. 1 and 2, a multifunctional drink making apparatus may include a main body 001 that includes a water storage tank 002, a cold water pump 008 and a hot water pump 009 which are connected with the water storage tank 002 respectively. In one embodiment, the water storage tank 002 can be directly connected with a tap water pipe or other water sources. A plurality of water filters 010 may be arranged between the water storage tank 002 and the tap water pipe. In one embodiment, the water filters 010 can be disposed inside the drink making apparatus. In another embodiment, the water filters 010 can be disposed outside the drink making apparatus.

The cold water pump 008 and the hot water pump 009 are connected with a cold water outlet 003 and a hot water outlet 004 through pipelines respectively. A sterilization device 011 is disposed on each of the cold water pump 008/the cold water outlet 003 as well as the hot water pump 009/the hot water outlet 004. In one embodiment, the sterilization device 011 is an ultraviolet sterilization device. In another embodiment, the sterilization device 011 is an ozone sterilization device or other disinfection and sterilization devices with equivalent effects. The multifunctional drink making apparatus may further include a rapid heating component 012 disposed between the hot water pump 009 and the hot water outlet 004 to quickly heat up the water.

It is important to note that the drink making apparatus includes an intelligent control display 005 connected with the Internet and can be used to control the rapid heating component 012, the cold water pump 008 and the hot water pump 009 with a switch 013. The intelligent control display 005 can be connected with a mobile terminal or the Internet through a wireless module and a wired router module arranged therein to control the rapid heating component 012, the cold water pump 008 and the hot water pump 009, so an external electronic device can be used to remotely control of output of cold water and hot water of the drink making apparatus in the present invention.

The drink making apparatus further includes a bench 006 arranged below the hot water outlet 004 and a detachable funnel 014 is provided to receive ground coffee, tea leaves and the like. A cup space 007 is used for placing a cup therein below the bench 006 and the funnel 014 is connected with the cup space 007, and a filtering unit is disposed between the funnel 014 and the cup space 007, so that the intelligent control display 005 can be used to control the hot water outlet 004 to brew coffee, tea leaves or the like in the funnel 014. Again, the intelligent control display 005 is connected with the wireless module, so it can be remotely controlled by external electronic devices.

The present invention is advantageous because the drink making apparatus can be directly connected with tap water, and a user can connect multiple water filters 010 internally or externally from the water storage tank 002 to improve the water quality to solve the issue of frequently replacing the water storage tank 002. The user can replace the water filters 010 and wash the water storage tank 002 periodically to control and maintain the water quality. Moreover, the drink making apparatus includes an intelligent control display 005 to intelligently control the hot water output to brew coffee, tea or the like according to the preference of the user. More importantly, the intelligent control display screen 005 is connected with the wireless module, so the user can use an external electronic device to control the drink making apparatus through the intelligent control display to achieve the goal of internet of things, and increase the convenience and practicability of the drink making apparatus.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A multifunctional drink making apparatus comprising a main body that includes a water storage tank, a cold water pump and a hot water pump which are connected with the water storage tank respectively; a cold water outlet connected with the cold water pump while a hot water outlet connected with the hot water pump; a sterilization device disposed on each of the cold water outlet and the hot water outlet; a rapid heating component disposed between the hot water pump and the hot water outlet to quickly heat up the water; an intelligent control display to control the rapid heating component, the cold water pump and the hot water pump; and a bench under the hot water outlet having a funnel to receive grounded coffee powders, tea leaves, or the like.

2. The multifunctional drink making apparatus of claim 1, wherein cup space is used for placing a cup therein below the bench and the funnel is connected with the cup space.

3. The multifunctional drink making apparatus of claim 1, wherein a filtering unit is disposed between the funnel and the cup space, so that the intelligent control display is configured to control the hot water outlet 004 to brew coffee, tea leaves or the like in the funnel.

4. The multifunctional drink making apparatus of claim 1, wherein a plurality of water filters are disposed inside or outside the water storage tank.

5. The multifunctional drink making apparatus of claim 1, wherein the intelligent control display is connected with a mobile terminal or the Internet through a wireless module and a wired router module arranged therein.

6. The multifunctional drink making apparatus of claim 1, wherein the sterilization device is an ultraviolet sterilization device, an ozone sterilization device or other disinfection and sterilization devices with equivalent effects.
